(19) United States
(12) Patent Application Publication
(10) Pub. No.: US 2003/0233467 A1
(43) Pub. Date: Dec. 18, 2003

(54) Data transmission apparatus, data transmission method and data transmission program that can select optimal transmission mode for each recipient

(75) Inventor: Kenji Ogasawara, Toda-Shi (JP)

Correspondence Address: BURNS, DOANE, SWECKER & MATHIS, L.L.P., P.O. Box 1404, Alexandria, VA, 22313-1404, US

(73) Assignee: MINOLTA CO., LTD.

(21) Appl. No.: 10/397,408

(22) Filed: Mar. 27, 2003

(30) Foreign Application Priority Data
Mar. 27, 2002 (JP) 2002-88205

(51) Int. Cl. G06F 15/16

(52) U.S. Cl. 709/232

(57) ABSTRACT

A data transmission apparatus permitting a recipient to receive sent data easily and in an appropriate manner. The apparatus is provided with a storage device for storing for each recipient multiple transmission modes having different data distribution methods and the order of priority among said multiple transmission modes, an interface for accepting designation of a recipient for data to be sent, and a transmission controller for specifying one transmission mode from among the multiple transmission modes stored in the storage device for the recipient designated via the interface, in accordance with the order of priority, and for sending the data using the specified transmission mode.

This application is based on Japanese Patent Application No. 2002-88205 filed in Japan on Mar. 27, 2002, the entire content of which is hereby incorporated by reference.

### BACKGROUND OF THE INVENTION

1. Field of the Invention

The present invention pertains to a data transmission technology, and more particularly to a data transmission technology that allows selection of the optimal transmission mode for each recipient.

2. Description of Related Art

With the increasing use of networks such as the Internet, transmission and receipt of electronic data over a network has become an effective means of information transmission in recent years.

Methods of electronic data transmission over a network include methods by which electronic data is sent to the recipient as is and methods by which electronic data is printed on paper at the recipient's location. The methods by which electronic data is printed out on paper at the recipient's location include Internet fax, wherein an e-mail to which an electronic data file is attached is sent and the file is printed out at the recipient's location, and remote printing, wherein electronic data is sent to a remote printer for printing.

However, where the methods by which electronic data is sent to the recipient as is are used, if the recipient needs to receive the electronic data in printed form, for example, the recipient must designate a specific printer through a prescribed operation and separately instruct printing of the electronic data, requiring that the recipient perform complex operations.

In addition, it is not guaranteed that the Internet fax receiving apparatus will be located near the recipient. Furthermore, even if the Internet fax receiving apparatus is located quite close to the recipient, the inconvenience exists that when Internet fax is used, data that does not have a specific file format cannot be handled.

Furthermore, a printer that is capable of remote printing is not always located near the recipient. Even if such a printer is located quite close to the recipient, because the relationship between the printer and the recipient who is to receive the printed matter is often unclear, it is difficult as a practical matter to use such a method.

As described above, it is difficult for the sender to determine the method of transmission of electronic data by which it is easiest for the recipient to receive data, as it varies depending on the recipient. Consequently, the problems have arisen that electronic data is sent using an inappropriate method, requiring the recipient to perform complex operations, or that the sender is forced to perform extra work in order to determine and use the recipient's preferred transmission method.

### OBJECT AND SUMMARY

An object of the present invention is to provide an improved data transmission technology that resolves the problems identified above.

Another object of the present invention is to provide a data transmission technology that is convenient for both the sender and the recipient of data and permits the recipient to receive the sent data easily and in an appropriate manner.

These objects are attained by providing a data transmission apparatus comprising, for example:

a storage device that stores for each recipient multiple transmission modes having different data distribution methods and the order of priority among said multiple transmission modes;

an interface that accepts designation of a recipient for the data to be sent; and

a transmission controller that specifies one transmission mode from among the multiple transmission modes stored in the storage device in accordance with the order of priority for the recipient designated via the interface, and that sends the data using the specified transmission mode.

In the data transmission apparatus described above, it is preferred that the transmission controller specifies the transmission mode having the next higher priority position if data transmission using the originally specified transmission mode did not end normally.

In the data transmission apparatus described above, the transmission controller may obtain the transmission mode information or order of priority information from outside the data transmission apparatus, and cause the transmission modes or order of priority to be stored in the storage device based on the obtained information. The order of priority information comprises, for example, the frequency of use of the data receiving apparatuses by each recipient.

The data transmission apparatus described above may further include an image reader that reads original documents and obtains image data therefrom, and send the image data obtained by this image reader.

In the data transmission apparatus described above, the multiple transmission modes may have different data transmission protocols or different data receiving apparatuses.

In the data transmission apparatus described above, the multiple transmission modes may include two or more transmission modes among facsimile, Internet facsimile, e-mail and remote printing.

### BRIEF DESCRIPTION OF THE DARWINGS

These and other objects and features of the present invention will become clear from the following description taken in conjunction with the preferred embodiments thereof with reference to the accompanying drawings, in which:

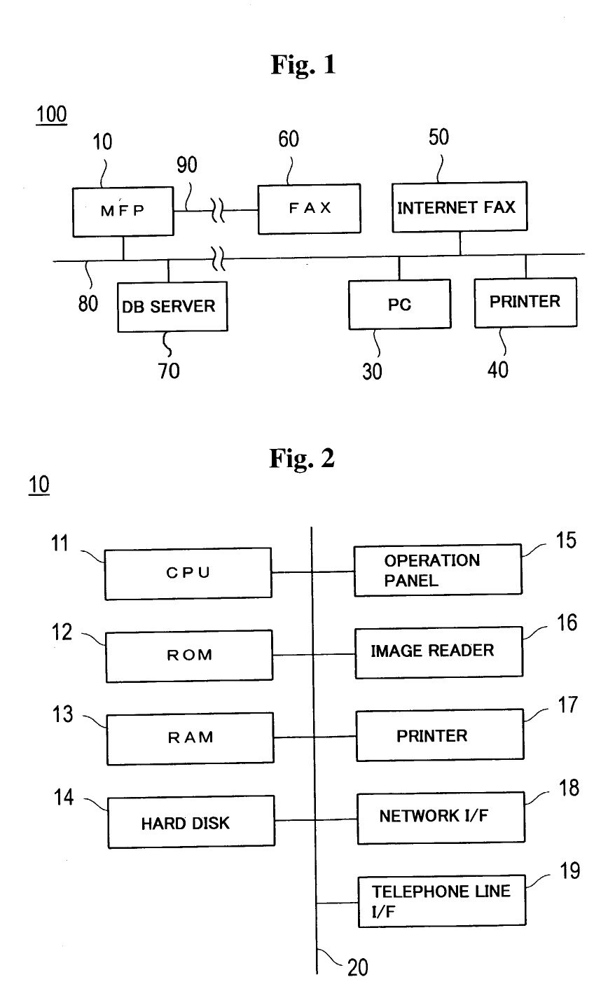

FIG. 1 is a block diagram showing the overall construction of a data transmission/receiving system including an MFP 10, an embodiment of the data transmission apparatus of the present invention;

FIG. 2 is a block diagram showing one example of the construction of the MFP 10;

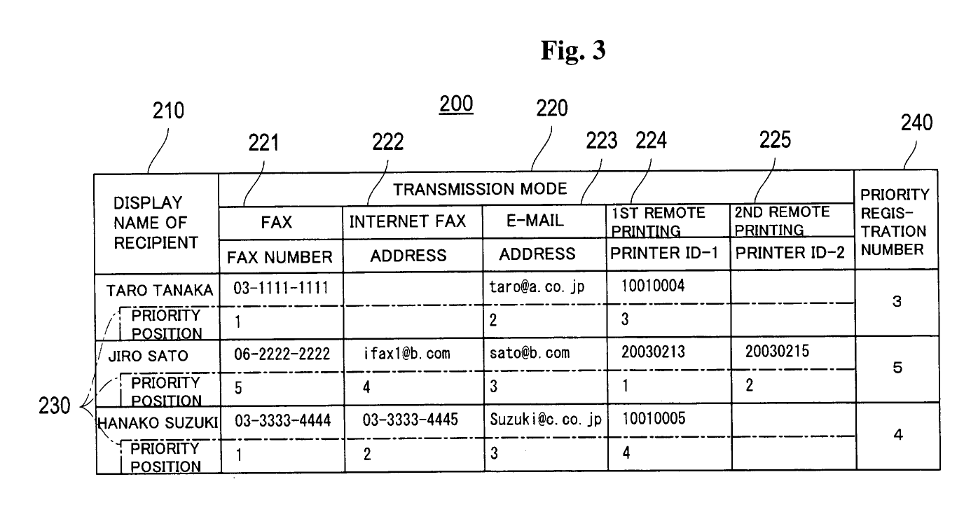

FIG. 3 is a drawing showing one example of an address book; and

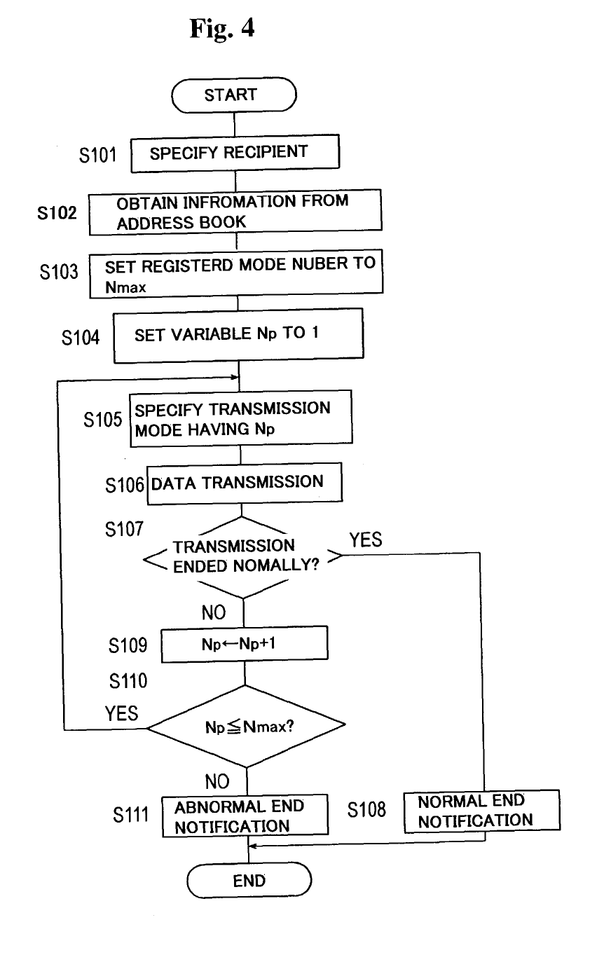

FIG. 4 is a flow chart showing the sequence of data transmission operations performed by the MFP 10.

### DETAILED DESCRIPTION OF THE PREFERRED EMBODIMENTS

A preferred embodiment of the present invention is described below with reference to the accompanying drawings.

FIG. 1 is a block diagram showing the overall construction of the data transmission/receiving system that incorporates the data transmission apparatus pertaining to an embodiment of the present invention.

The data transmission/receiving system 100 shown in FIG. 1 has a multi-function peripheral (MFP) 10 that functions as a data transmission apparatus, a personal computer 30, a printer 40, an Internet facsimile apparatus (Internet fax) 50 and a database server 70, which are interconnected such that they can communicate with each other over a network 80. The data transmission/receiving system 100 also has a facsimile apparatus (fax) 60, and the MFP 10 and fax 60 are intercommunicably connected over a telephone line 90.

The network 80 includes LANs that connect computers and network apparatuses using a standard such as Ethernet (registered trademark), Token Ring, FDDI or the like, WANs comprising LANs connected using dedicated lines, and the Internet. The type and number of the apparatuses connected to the network 80 are not limited to the example shown in FIG. 1.

FIG. 2 is a block diagram showing one example of the construction of the MFP 10.

With reference to FIG. 2, the MFP 10 includes a CPU 11, a ROM 12, a RAM 13, a hard disk 14, an operation panel 15, an image reader 16, a printer 17, a network interface 18 and a telephone line interface 19, which are mutually connected via a bus 20 such that signals can be sent and received therebetween.

The CPU 11 performs control of the above various components and various calculations according to programs. The ROM 12 stores various programs and data. The programs stored in the ROM 12 include the data transmission program described below. The data transmission program may be stored in the hard disk 14, however. The RAM 13 functions as a work area for the temporary storage of programs and data.

The hard disk 14 is used to store various programs and data and to temporarily save image data or the like that was obtained via image processing. The programs stored in the hard disk 14 include a client program by which to use the communication services provided by a mail server not shown. The hard disk 14 has an address book in which to store and register recipient information indicating a recipient, such as an e-mail address, and this address book is utilized during data transmission. The address book information is stored in the hard disk 14, but is loaded to the RAM 13 when the apparatus is booted or when the user performs an operation.

The operation panel 15 includes a touch panel used for the display of various information and the input of various instructions, a numerical key pad by which to set a number of copies to be made, etc., a start key by which to instruct commencement of an operation, a stop key by which to instruct cessation of an operation, a reset key by which to initialize various setting parameters, and the like.

The image reader 16 uses a light source to illuminate the original document which is placed at a prescribed reading position, performs photoelectric conversion of the reflected light from the original document using light-receiving elements such as CCDs, and generates image data (bitmap data) from the electric signals. The image reader 16 includes an automatic document feeder (ADF) that conveys each page of the original document to the prescribed reading position.

The printer 17 prints on a recording medium such as paper various data such as image data obtained by reading an original document using the image reader 16 and image data received from an external apparatus.

The network interface 18 is an interface enabling connection to the network 80 and communication with other apparatuses on the network. The telephone line interface 19 is an interface enabling connection to the telephone line 90.

The MFP 10 has, in addition to its function as a regular copying machine that performs copying of original documents, a network scan function whereby it reads an original document to obtain image data, attaches to an e-mail the file of image data thus obtained and sends it to an apparatus such as the personal computer 30 over the network 80, an Internet fax function whereby it attaches to an e-mail the file of image data thus obtained and sends it to the Internet fax 50 connected to the network 80 for printing, a remote printing function whereby it sends the image data thus obtained to the printer 40 over the network 80 for printing, and a fax function whereby it sends the image data thus obtained to the fax 60 via the telephone line 90 for printing.

The database server 70 stores user information regarding all users that use the apparatuses within the system. This user information includes individual user information such as e-mail address information, and may be referred to during registration of necessary information in the address book, but is not essential.

FIG. 3 shows one example of the address book stored on the hard disk 14.

The address book 200 shown in FIG. 3 has a display name column 210 and a transmission mode column 220. The display names for recipients of data to be transmitted can be registered in the display name column 210. During data transmission, the display names of the recipients registered in the display name column 210 are displayed on the operation panel 15, prompting the user (the sender) to select one or more recipients. Multiple transmission modes involving different data distribution methods can be registered in the transmission mode column 220 for each recipient. The transmission modes have different data communication protocols or data receiving apparatuses. Therefore, specifically, the recipient information that indicates the data recipient can be registered in the transmission mode column 220. In this embodiment, the transmission mode column 220 has a fax column 221, an Internet fax column 222, an e-mail column 223, a first remote printing column 224, and a second remote printing column 225. Fax numbers can be registered in the fax column 221, Internet fax addresses can be registered in the Internet fax column 222, and e-mail addresses can be registered in the e-mail column 223. The identification codes of the printers that the data recipient indicated as a display name in the display name column 210 finds easy to use can be registered in the first and second remote printing columns 224 and 225. A printer identification code is a unique ID used within the data transmission/receiving system 100, and comprises an eight-digit number as shown in FIG. 3, for example.

In this embodiment, as descried above, fax, Internet fax, e-mail and remote printing (two types) can be registered as transmission modes. The transmission mode column 220 need not have all of the multiple transmission modes shown in the columns 221-225, and any of the transmission mode columns may be omitted. In addition, other transmission mode columns may be added as well. Multiple transmission mode columns may be included for the same transmission protocol as in the case of the first and second remote printing. In this embodiment, the identification code of the printer that is easiest to use is registered in the first remote printing column 224 and the identification code of the printer that is the second easiest to use is registered in the second remote printing column 225. Any of the columns 221-225 of the transmission mode column 220 may be left blank with no recipient information shown, and a blank transmission mode column indicates that the transmission mode is not available.

The address book 200 has an order of priority column 230 and a number of priority registrations column 240. The priority position of each transmission mode available regarding a given recipient can be registered in the order of priority column 230. In this example, the order of priority is expressed as numbers 1, 2, etc., starting with the highest priority position. The number of priority registrations column 240 shows the number of transmission modes registered for each recipient. It is also acceptable if other information such as a telephone number or address is added to the address book 200 in addition to the above information items.

As shown in FIG. 3, fax, e-mail and remote printing (one type) are registered as the transmission modes available for the recipient display name ‘Taro Tanaka’, for example (consequently, there are three registered transmission modes), and these transmission modes are prioritized in the order of fax, e-mail and remote printing. FIG. 1 shows only some of the receiving apparatuses corresponding to the recipient information shown in FIG. 3, and the rest is omitted.

The transmission mode column 220 and order of priority column 230 of the address book 200 must be registered for each recipient in advance before processing for data transmission takes place. Registration in the address book 200 is performed by the user such as the administrator or the sender. In this case, the user can use the user information, including the user individual information such as e-mail address and fax number, stored in the database server 70. The data recipient user may perform registration or correction regarding the address book 200 as well.

The database server 70 can store for each user as information related to the order of priority the data reception frequency (use frequency) of the apparatus that received the data sent to the user (the recipient). For example, where the receiving apparatus is a printer, when the user instructs that a given printer perform printing, the user ID of the user who logged into the personal computer and the printer ID of the outputting printer can be sent to the database server 70, enabling the database server 70 to calculate the use frequency of the printer for each user and store such information. It is also acceptable if the ID of the user who used the printer and the use frequency information for that user are stored in the printer, and information regarding the user ID, printer ID and printer use frequency for that user is obtained for storage by the database server 70 that requests such information from the printer at prescribed intervals.

Registration in the transmission mode column 220 or the order of priority column 230 of the address book 200 is not limited to the registration performed by the user as described above. In other words, the present invention may adopt a construction in which transmission mode information or order of priority information is obtained for each user from the user information stored in the external database server 70, and the transmission mode or order of priority is automatically written in the address book 200 based on the obtained information. In this embodiment, the identification code of the printer used most frequently among all the available printers is entered in the first remote printing column 224, and the identification code of the printer used with the second highest frequency among all the available printers is entered in the second remote printing column 225.

The sequence of the data transmission operations performed by the MFP 10 will now be explained below with reference to FIG. 4. The algorithm shown in the flow chart in FIG. 4 is stored as a program in the ROM 12 and is executed by the CPU 11.

Where the user (the sender) wants to distribute to other users (the recipients) image data obtained from reading of an original document via the MFP 10, the sender selects via the operation panel 15 any number of display names from among the display names for recipients registered in the address book 200. When the start key is thereafter pressed, the original document placed at a prescribed reading position is read by the image reader 16, whereby image data is obtained. The image data thus obtained is distributed to the recipients via the data transmission operations explained below. Where the display names for multiple recipients are selected, the same routine of the data transmission operations is performed for each recipient.

In step S101, a recipient for the data transmission routine is specified based on the display name selected by the sender via the operation panel 15.

In step S102, all information available from the address book 200 regarding the recipient specified in step S101 is obtained.

In step S103, the number of registered transmission modes Nmax is set based on the information from the address book 200 obtained in step S102.

In step S104, the variable Np indicating the priority position of the transmission mode to be used is set to ‘1’.

In step S105, the transmission mode having the priority position Np is specified based on the information shown in the transmission mode column 220 and the order of priority column 230 of the address book 200.

In step S106, the image data obtained by the image reader 16 is sent to the recipient specified in step S101 in accordance with the transmission mode specified in step S105.

In step S107, it is determined whether or not the transmission carried out in step S106 ended normally. In other words, the CPU 11 monitors the data transmission result and determines whether or not there has been an error in the transmission. Where the transmission mode is remote printing, the CPU 11 may check the state of the registered printer periodically or prior to transmission and store information regarding whether or not the printer is available in the RAM 13 or the like. Where the printer is not available, it is acceptable if the CPU 11 determines in step S107 that the transmission did not end normally without performing transmission in step S106.

Where the transmission ended normally (YES in step S107), the operation of the step S108 is executed.

In step S108, a normal end notification is issued to notify the sender that the transmission ended normally. It is preferred that the normal end notification include information that indicates the type of transmission mode used. This normal end notification is displayed on the operation panel 15 of the MFP 10 or printed out by the printer 17. The normal end notification may be sent to the personal computer of the user (not shown) in the form of an e-mail.

Where the transmission did not end normally, on the other hand (NO in step S107), the operation of step S109 is executed.

In step S109, the variable Np is increased by 1. In other words, the transmission mode to be used is changed to the mode having the next higher priority position.

In step S110, it is determined whether or not the value of the variable Np is equal to or less than the number of registered transmission modes Nmax.

Where Np≦Nmax (YES in step S110), it is determined that the transmission mode having the next higher priority position is registered, and the CPU 11 returns to the operation of step S105. Where Np≦Nmax is untrue (NO in step S107), on the other hand, it is determined that the transmission mode having the next higher priority position is not registered and that an error has occurred with regard to all registered transmission modes, whereupon the operation of step S111 is executed.

In step S111, an abnormal end notification is issued to notify the sender that the transmission to the specified recipient did not end normally. This abnormal end notification is displayed on the operation panel 15 of the MFP 10 or printed out by the printer 17. The abnormal end notification may be sent to the personal computer of the sender (not shown) in the form of an e-mail.

As described above, according to this embodiment, recipients for the data to be sent are specified, a transmission mode is specified in accordance with the order of priority registered in the order of priority column 230 and assigned to the multiple transmission modes that are registered in the transmission mode column 220 in advance regarding each specified recipient and have different data distribution methods, and the data is sent via the specified transmission modes. Therefore, the sent data can be easily received by each recipient in an appropriate manner, significantly increasing the level of convenience for both the sender and the recipient of the data.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

An explanation was provided in the above embodiment using an MFP as an example of the data transmission apparatus, but the present invention is not limited to this implementation. It can be applied in other apparatuses such as network scanners that have a function by which to obtain image data via reading an original document and send the obtained image data, copying machines or image processing apparatuses, for example. The present invention can also be applied in the transmission of image data stored in such apparatuses as personal computers and servers. The present invention is preferably applied in the transmission of image data, but is not limited to this implementation, and can be applied in connection with the transmission of other types of data as well.

The operations shown in FIG. 4 and performed by the data transmission apparatus of the present invention can be realized by a dedicated hardware circuit or by a programmed computer. Such a program may be provided via a computer-readable recording medium such as a flexible disk or CD-ROM, or may be downloaded over a network such as the Internet. In this case, the program recorded on a computer-readable recording medium is normally forwarded to the storage device such as the hard disk and stored thereon. Such a program may be provided as a stand-alone application software program or may be incorporated in the software of the apparatus as a function thereof.

What is claimed is:

1. A data transmission apparatus comprising:
a storage device for storing for each recipient multiple transmission modes having different data distribution methods and the order of priority among said multiple transmission modes;
an interface for accepting designation of a recipient for data to be sent; and
a transmission controller for specifying one transmission mode from among the multiple transmission modes stored in the storage device for the recipient designated via the interface, in accordance with the order of priority, and for sending the data using the specified transmission mode.

2. A data transmission apparatus as claimed in claim 1, wherein the transmission controller specifies a transmission mode having the next higher priority position if data transmission using the originally specified transmission mode did not end normally.

3. A data transmission apparatus as claimed in claim 1, wherein the transmission controller obtains the transmission mode information or order of priority information from outside the data transmission apparatus, and causes the transmission modes or order of priority to be stored in the storage device based on the obtained information.

4. A data transmission apparatus as claimed in claim 3, wherein the order of priority information comprises the frequency of use of the data receiving apparatuses by each recipient.

5. A data transmission apparatus as claimed in claim 1, further comprising an image reader for reading original documents and obtaining image data therefrom, and wherein the image data to be sent comprise image data obtained by the image reader.

6. A data transmission apparatus as claimed in claim 1, wherein the multiple transmission modes have different data transmission protocols or different data receiving apparatuses.

7. A data transmission apparatus as claimed in claim 1, wherein the multiple transmission modes include two or more transmission modes among facsimile, Internet facsimile, e-mail and remote printing.

8. A data transmission method used in a data transmission apparatus, comprising the steps of:
1) accepting designation of a recipient for data to be sent;
2) specifying one transmission mode from among multiple transmission modes stored for the recipient designated in the step 1, in accordance with the order of priority stored for the multiple transmission modes, wherein the multiple transmission modes have different data distribution methods; and
3) sending the data using the transmission mode specified in the step 2.

9. A computer program product for causing a computer to execute data transmission processing comprising the steps of:
1) accepting designation of a recipient for data to be sent;
2) specifying one transmission mode from among multiple transmission modes stored for the recipient designated in the step 1, in accordance with the order of priority stored for the multiple transmission modes, wherein the multiple transmission modes have different data distribution methods; and
3) sending the data using the transmission mode specified in the step 2.

10. A data transmission apparatus comprising:
a storage device for storing for each recipient multiple transmission modes having different data distribution methods and the order of priority among said multiple transmission modes;
an interface for accepting designation of a recipient for data to be sent;
specifying means for specifying one transmission mode from among the multiple transmission modes stored in the storage device for the recipient designated via the interface, in accordance with the order of priority; and
sending means for sending the data using the specified transmission mode.

11. A data transmission apparatus as claimed in claim 10, wherein the specifying means specifies a transmission mode having the next higher priority position if data transmission using the originally specified transmission mode did not end normally.

12. A data transmission apparatus as claimed in claim 10, further comprising:
obtaining means for obtaining the transmission mode information or order of priority information from outside the data transmission apparatus; and
registration means for causing the transmission modes or order of priority to be stored in the storage device based on the obtained information.

13. A data transmission apparatus as claimed in claim 12, wherein the order of priority information comprises the frequency of use of the data receiving apparatuses by each recipient.

14. A data transmission apparatus as claimed in claim 10, further comprising an image reader for reading original documents and obtaining image data therefrom, and wherein the image data to be sent comprise image data obtained by the image reader.

15. A data transmission apparatus as claimed in claim 10, wherein the multiple transmission modes have different data transmission protocols or different data receiving apparatuses.

16. A data transmission apparatus as claimed in claim 10, wherein the multiple transmission modes include two or more transmission modes among facsimile, Internet facsimile, e-mail and remote printing.
